(19) United States
(12) Patent Application Publication
(10) Pub. No.: US 2024/0094701 A1
(43) Pub. Date: Mar. 21, 2024

(54) INFORMATION PROVISION DEVICE, INFORMATION PROVISION METHOD, AND STORAGE MEDIUM STORING INFORMATION PROVISION PROGRAM

(71) Applicant: Mitsubishi Electric Corporation, TOKYO (JP)

(72) Inventors: Shingo MINE, Tokyo (JP); Kei GOMITA, Tokyo (JP)

(73) Assignee: Mitsubishi Electric Corporation, TOKYO (JP)

(21) Appl. No.: 18/510,251

(22) Filed: Nov. 15, 2023

Related U.S. Application Data
(63) Continuation of application No. PCT/JP2021/022446, filed on Jun. 14, 2021.

(51) Int. Cl. G05B 19/4097; G06F 30/17; G06F 30/27

(52) U.S. Cl. CPC G05B 19/4097; G06F 30/17; G06F 30/27

(57) ABSTRACT

An information provision device includes: processing circuitry to acquire disclosure range information indicating a range of information regarding a target device that is permitted to be disclosed to an information provision destination; and to acquire device design data as data regarding design of the target device from a database storing the device design data, to acquire device parameter adjustment data as data regarding device parameters determining operation of the target device from a database storing the device parameter adjustment data, to extract data from the device design data and the device parameter adjustment data depending on the disclosure range information, and to generate disclosure data to be provided to the information provision destination, from the extracted data.

### CROSS-REFERENCE TO RELATED APPLICATION

This application is a continuation application of International Application No. PCT/JP2021/022446 having an international filing date of Jun. 14, 2021.

### BACKGROUND OF THE INVENTION

### 1. Field of the Invention

The present disclosure relates to an information provision device, an information provision method, and an information provision program.

### 2. Description of the Related Art

There are cases where a product manufacturer (e.g., information provider that provides information) that manufactures a product by installing a target component supplied from a component supplier (e.g., information recipient that receives the information) in the product provides the component supplier with information necessary for analysis for inspecting the performance of the target component (e.g., shape information regarding the product in which the target component is installed). In such cases, the product manufacturer needs to execute work of determining a disclosure range as a range of information that may be provided to the component supplier. To support this work, there has been proposed a design support device that determines the disclosure range based on an evaluation result (e.g., trading results) regarding the component supplier and extracts the information necessary for the analysis of the target component from information in the disclosure range. See Patent Reference 1, for example.
Patent Reference 1: Japanese Patent Application Publication No. 2018-147012 (Claim 1 and FIG. 1, for example).

While the above-described conventional device determines the disclosure range of the shape of a target device, as the product in which the target component is installed, based on the evaluation result of the information recipient, the device has not taken into consideration the disclosure range in regard to design data of the target device and adjustment data of parameters determining the operation of the target device.

### SUMMARY OF THE INVENTION

An object of the present disclosure is to provide an information provision device, an information provision method and an information provision program that make it possible to appropriately set the design data and the parameter adjustment data of the target device.

An information provision device in the present disclosure includes: processing circuitry to acquire disclosure range information indicating a range of information regarding a target device that is permitted to be disclosed to an information provision destination; and to acquire device design data as data regarding design of the target device from a database storing the device design data, to acquire device parameter adjustment data as data regarding device parameters determining operation of the target device from a database storing the device parameter adjustment data, to extract data from the device design data and the device parameter adjustment data depending on the disclosure range information, and to generate disclosure data to be provided to the information provision destination, from the extracted data.

An information provision method in the present disclosure is a method executed by an information provision device, including acquiring disclosure range information indicating a range of information regarding a target device that is permitted to be disclosed to an information provision destination; and acquiring device design data as data regarding design of the target device from a database storing the device design data, acquiring device parameter adjustment data as data regarding device parameters determining operation of the target device from a database storing the device parameter adjustment data, extracting data from the device design data and the device parameter adjustment data depending on the disclosure range information, and generating disclosure data to be provided to the information provision destination, from the extracted data.

According to the present disclosure, the design data and the parameter adjustment data of the target device can be set appropriately.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a diagram schematically showing a configuration of a system employing an information provision device according to a first embodiment;

FIG. 2 is a diagram schematically showing a configuration of the information provision device according to the first embodiment;

FIG. 3 is a diagram showing a configuration of device design data;

FIG. 4 is a diagram showing a configuration of integrated device design data;

FIG. 5 is a diagram showing the hardware configuration of a system employing the information provision device according to the first embodiment;

FIG. 6 is a flowchart showing a generation process of device design data;

FIG. 7 is a flowchart showing a generation process of device parameter adjustment data;

FIG. 8 is a flowchart showing a generation process in a disclosure data generation unit;

FIG. 9 is a diagram showing examples of disclosure range information and disclosed information;

FIG. 10 is a diagram showing examples of the disclosure range information and the disclosed information;

FIG. 11 is a diagram showing examples of the disclosure range information and the disclosed information;

FIG. 12 is a diagram showing an example of a relationship between the disclosure range information and a real state of trading;

FIG. 13 is a diagram showing examples of the disclosure range information and the disclosed information;

FIG. 14 is a diagram showing examples of the disclosure range information and the disclosed information;

FIG. 15 is a diagram showing examples of the disclosure range information and the disclosed information;

FIG. 16 is a diagram showing examples of a disclosed shape in the examples in FIG. 15;

FIG. 17 is a diagram showing examples of the disclosed information;

FIG. 18 is a diagram showing the disclosed information in the examples in FIG. 17;

FIG. 19 is a diagram showing an example of a screen displaying an object in a rectangular solid shape and design data while associating them with each other;

FIG. 20 is a diagram showing a configuration of a system employing an information provision device according to a second embodiment;

FIG. 21 is a diagram showing a hardware configuration of a system employing an information provision device according to a third embodiment;

FIG. 22 is a diagram showing a hardware configuration of a system employing an information provision device according to a fourth embodiment;

FIG. 23 is a flowchart showing a generation process of disclosure data executed by the information provision device according to the fourth embodiment;

FIG. 24A shows an example of imparting reference data as attribute information in XML and extracting information depending on the disclosure range information, and FIG. 24B shows an example of imparting the reference data as element information and extracting information depending on the disclosure range information;

FIG. 25 is a diagram showing an example of a display screen including a disclosure range designation field; and

FIG. 26 is a diagram showing an example of disclosure data display software (S/W) and the display screen.

### DETAILED DESCRIPTION OF THE INVENTION

An information provision device, an information provision method, and an information provision program according to each embodiment will be described below with reference to the drawings. The following embodiments are just examples and it is possible to appropriately combine embodiments and appropriately modify each embodiment.

### First Embodiment

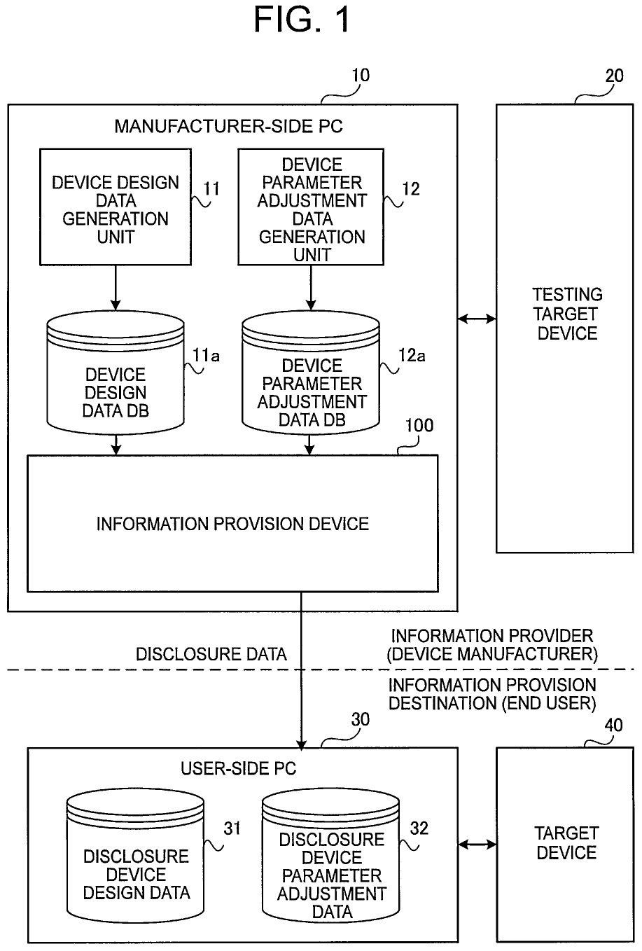

FIG. 1 is a diagram schematically showing a configuration of a system employing an information provision device 100 according to a first embodiment. In the system shown in FIG. 1, a manufacturer-side PC 10 as a PC (Personal Computer) of an information provider (e.g., device manufacturer) provides a user-side PC 30 as a PC of an information provision destination (e.g., end user) with part or all of device design data and device parameter adjustment data, in an unprocessed or processed state, as disclosure data. The method of providing the disclosure data can be transmission of the disclosure data via a network such as the Internet, provision of an information recording medium such as an optical disc storing the disclosure data, or the like. The method of providing the disclosure data can also be sharing of data in a cloud environment or data transfer to an industrial PC or a programmable indicator.

In general, the device design data is generated by using software as a CAD (Computer Aided Design) tool installed in the manufacturer-side PC 10 and is stored in a storage device as a database (DB), namely, a device design data DB 11a. The device design data includes one or more items of data out of machine design data as data regarding machine design of a target device 40, electric design data as data regarding electric design of the target device 40, and control design data as data regarding control design of the target device 40. A device design data generation unit 11 and the device design data DB 11a may also be included in a PC different from the manufacturer-side PC 10 including the information provision device 100.

The device parameter adjustment data is generated by using, for example, a testing target device 20 connected to the manufacturer-side PC 10 and is stored in a storage device as a database (DB), namely, a device parameter adjustment data DB 12a. The testing target device 20 is a device having the same functions as the target device 40 delivered to the information provision destination (in FIG. 1, the target device 40 connected to the user-side PC 30).

The disclosure data provided to the user-side PC 30 of the information provision destination is stored in a storage device of the user-side PC 30 as disclosure device design data 31 and disclosure device parameter adjustment data 32. The end user can use the data stored in the user-side PC 30 for the operation, maintenance, repair, and the like of the target device 40 by having the data displayed on a display device.

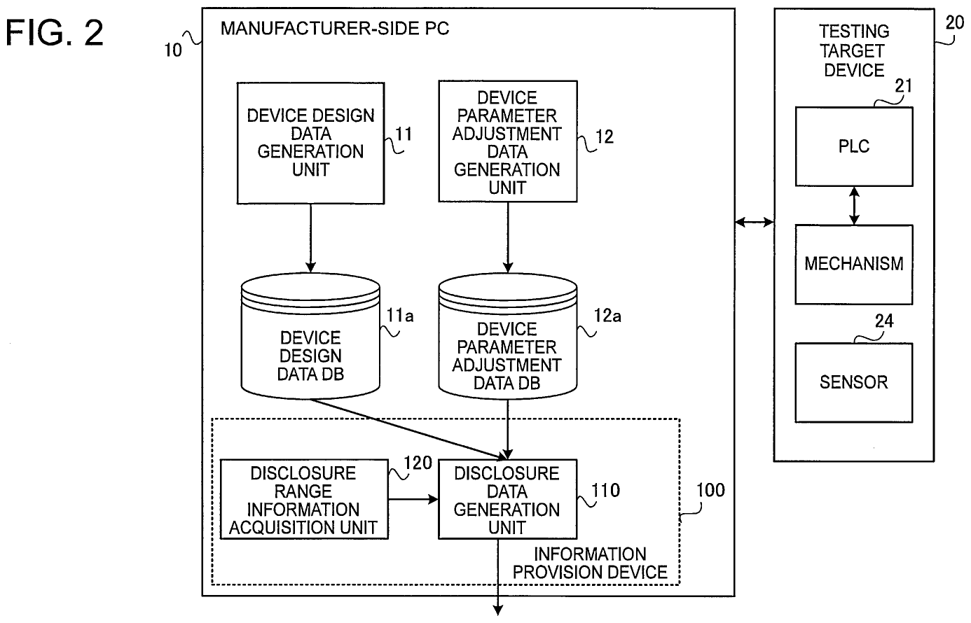

FIG. 2 is a diagram schematically showing a configuration of the information provision device 100 according to the first embodiment. The information provision device 100 is a device capable of executing an information provision method according to the first embodiment. The information provision device 100 includes a disclosure range information acquisition unit 120 and a disclosure data generation unit 110. The disclosure range information acquisition unit 120 acquires disclosure range information indicating a range of information regarding the target device 40 that is permitted to be disclosed to the user-side PC 30. The disclosure range information is determined automatically depending on the end user or the target device 40, or inputted by an input operation by a person, for example. The disclosure range information is represented by a numerical value (e.g., 1, 2, 3, . . . ) indicating a disclosure level, for example.

The disclosure data generation unit 110 acquires the device design data as data regarding the design of the target device 40 from the device design data DB 11a, acquires the device parameter adjustment data as data regarding device parameters determining the operation of the target device 40 from the device parameter adjustment data DB 12a, extracts data from the device design data and the device parameter adjustment data depending on the disclosure range information acquired by the disclosure range information acquisition unit 120, and generates the disclosure data to be provided to the user-side PC 30, from the extracted data. The disclosure data generation unit 110 may also generate the disclosure data to be provided to the information provision destination, by processing the extracted data. The processing of the extracted data is, for example, one of a process of generating the disclosure data by concealing the extracted data by means of encryption, a process of generating the disclosure data by changing a level (i.e., detail level) according to the LOD (level of detail) technology, and a process of generating the disclosure data by replacing the extracted data with different data.

In the manufacturer-side PC 10 in FIG. 2, the device design data generation unit 11 generates the device design data and stores the device design data in the device design data DB 11a, and a device parameter adjustment data generation unit 12 generates the device parameter adjustment data by using the testing target device 20 having the same functions as the target device 40. The testing target device 20 includes a PLC (Programmable Logic Controller) 21 and various types of sensors 24. The device parameter adjustment data generation unit 12 collects the device parameter adjustment data by repeatedly executing a process of providing the device parameters to the PLC 21 and acquiring detection values of the sensors 24 and stores the collected device parameter adjustment data in the device parameter adjustment data DB 12a.

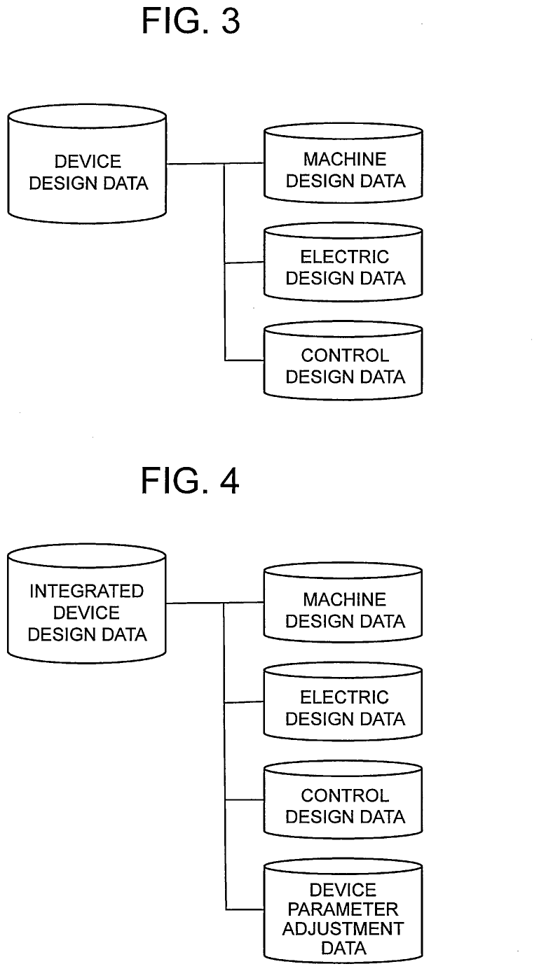

FIG. 3 is a diagram showing a configuration of the device design data generated by the device design data generation unit 11. The device design data in FIG. 3 is made up of the machine design data, the electric design data, and the control design data. In general, the device design data is generated by using a CAD tool installed in a PC. The machine design data in FIG. 3 includes data of a file generated by using a CAD tool for the machine design. The electric design data in FIG. 3 includes data of a file generated by using a CAD tool for the electric design. The control design data in FIG. 3 includes data of a file for a program for the control design.

FIG. 4 is a diagram showing a configuration of the device design data into which the device parameter adjustment data has been integrated. As shown in FIG. 4, the disclosure data generation unit 110 may generate the disclosure data as integrated device design data by integrating the device design data and the device parameter adjustment data together.

The device design by the device manufacturer is generally executed in a flow like order receipt, machine design, electric design, control design, and startup-adjustment. The order receipt involves explanation/proposal of the target device (or target facility) or the like by using a device catalog or the like. The machine design is executed based on machine specifications of the target device and includes preparation of assembly drawings, component drawings and so forth. The electric design is executed based on electric specifications of the target device and includes preparation of electric circuit diagrams, component arrangement diagrams, wiring diagrams and so forth. The control design is executed based on control specifications and includes preparation of a program and so forth.

The device design data is the outcome of the designing and includes, for example, electronic data of a specification document, design drawings, a design document, drawings, models, an instrument name table, an instruction manual and so forth. Specifically, the electronic data may include machine CAD data, electric CAD data, a control program, document files, image files, animation files, video files and so forth.

The device design data may include process design data. The process design data is data regarding a process from product design to production deployment included in the device design data. For example, the device design data may include line design data, data as a result of simulation by line simulator software, design/production management information based on CAD/CAM (Computer Aided Manufacturing)/CAE (Computer Aided Engineering), and so forth.

The machine design data includes shape data and mechanism data. Specifically, the machine design data includes data regarding drafting, processing, assembly-maintenance, standard/design criteria, strength calculation, performance calculation, material-component availability, machine introduction cost, machine running cost, delivery date, easiness of assembly, maintainability, designability, stability of quality, safety, environmental load, and work regarding analysis. In the machine design, the structure, and the mechanism of each machine element (screw, gear, motor, reduction gear, bearing, ball screw, linear guide, cylinder, hydraulic/pneumatic element, link, spring, seal, etc.) and each unit machine are drawn up as drawings, and materials, shapes and dimensions are determined so that strength and a deformation state of each component of the structure and the mechanism fit in permissible ranges. Further, when an already-existing machine element or unit machine is used, the shape, the dimensions, the material and so forth of each component are determined based on technical data of the machine element or unit machine. Based on the determined items, there are prepared a design document, a project diagram, data as the result of designing attributes and the like (e.g., shape, mechanism, color, material, etc.) of the device, document files of the specification document and the like, detailed drawings of components (component drawings), partial assembly drawings, assembly drawings of the whole machine, production drawings into which information for the production has been incorporated, and so forth.

The machine CAD data is data outputted from machine CAD software. As data formats, there are a native file that can be handled only on software from its respective vendor and an intermediate file that is used for data exchange between vendors. For example, as the machine CAD data, there are two-dimensional CAD data of an assembly drawing of the device, a detailed drawing of a component, or the like designed by using two-dimensional CAD software, three-dimensional CAD data of an assembly drawing of the device, a detailed drawing of a component, or the like designed by using three-dimensional CAD software, and an intermediate file for data exchange between CAD software and CAD software. Concrete examples of the machine CAD data include IGES (Initial Graphics Exchange Specification), STEP (Standard for the Exchange of Product model data), PARASOLID, JT (Jupiter Tessellation), and so forth.

The electric design data is design data regarding electricity. The electric design data is data outputted from electric CAD software, for example. Specifically, the electric design data includes determination of electric specifications, preparation of electric circuit diagrams, preparation of wiring diagrams (e.g., power system wiring diagrams and control system wiring diagrams), preparation of drawings describing shapes of connectors or the like, and so forth. The determination of the electric specifications includes selection of an inverter, selection of a breaker as a wiring breaker, determination of a control panel, a control console and a distribution panelboard, selection of a sensor and a motor, and so forth. The electric CAD data is data outputted from the electric CAD software.

The control design data is design data regarding the control, such as data that determines where, about what, and how measurement/control should be performed in the designing of a measurement control system, for example. The control design includes design of a PLC program and production of a touch panel. The control design data can include, for example, data obtained by executing the control design of the device by using software that generates the PLC program, drawing data designed by using software that generates the drawing data of the programmable indicator, document files or a DB of the specification document and the like associated with these data, and so forth. Specifically, the control design data can include a ladder diagram, drawing data for an indicator, and so forth.

The device parameter adjustment data is data regarding the parameters of the device. The device parameter adjustment data is, for example, history data obtained when the parameters of the device were adjusted in the past or data as a result of calculating recommendation values of device parameter adjustment by means of machine learning. Specifically, a CSV file, or data recorded in a DB or the like corresponds to the device parameter adjustment data. The device parameter adjustment data is worksite data, for example. The worksite data is data collected from the device or sensors adjunct to the device. For example, the worksite data can include data regarding operational status, failure or maintenance of the device, data of setting parameters of the device, data of materials, data of environment (temperature, humidity, etc.), data obtained as a result of a test, operational log data of the device, log data of operations on the device by a person, and so forth. Specifically, the device parameter adjustment data can include, for example, data of the device collected by “Edgecross”, produced by Edgecross Consortium as an open software platform in an edge computing region between the manufacturing site and IT, and stored in the CSV file format or in a DB and an operational log file of the device recorded by a data logging function of a sequencer and stored in the CSV format or an operation log file of the device recorded by a programmable indicator in the CSV or Unicode text file format. Further, examples of the device parameters include
(1) Setting parameter information regarding the settings of the device, such as set values of the device, customization design values, the model name, and ON/OFF of functions,
(2) Material parameter information regarding the materials of the device, such as quality, properties, etc. of each material,
(3) Environment parameter information regarding the environment in which the device is used, such as temperature, humidity and atmospheric pressure,
(4) Test parameter information regarding a test of the result of the device parameter adjustment, such as an operation time and a processing result, and so forth.

It is also possible to register such device parameters in a database and handle the registered device parameters as the device parameter adjustment data.

The disclosure data can also be integrative data obtained by integrating various types of data. The integrative data is an integrative model as data for integrative management of the machine design data, the electric design data, and the control design data. Specifically, the integrative model is described in a standard data format with published specifications based on XML, such as AutomationML.

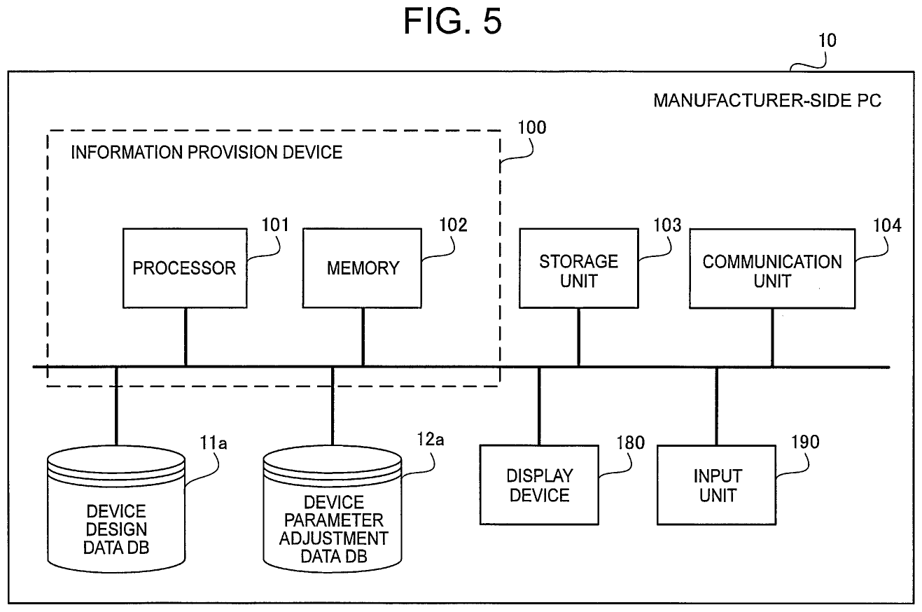

FIG. 5 is a diagram showing the hardware configuration of a system employing the information provision device 100 according to the first embodiment. The manufacturer-side PC 10 includes the information provision device 100, a storage unit 103, a communication unit 104, a display device 180, an input unit 190, the device design data DB 11a and the device parameter adjustment data DB 12a. The information provision device 100 includes a processor 101 and a memory 102.

As shown in FIG. 5, the information provision device 100 includes the processor 101 such as a CPU (Central Processing Unit) and the memory 102 as a volatile storage device. The memory 102 is, for example, a volatile semiconductor memory such as a RAM (Random Access Memory). The information provision device 100 may include a nonvolatile storage device such as a hard disk drive (HDD) or a solid state drive (SSD).

Functions of the information provision device 100 are implemented by processing circuitry. The processing circuitry can be either dedicated hardware or the processor 101 executing a program stored in the memory 102. The processor 101 can be any one of a processing device, an arithmetic device, a microprocessor, a microcomputer, and a DSP (Digital Signal Processor).

In the case where the processing circuitry is dedicated hardware, the processing circuitry is, for example, a single circuit, a combined circuit, a programmed processor, a parallelly programmed processor, an ASIC (Application Specific Integrated Circuit), an FPGA (Field-Programmable Gate Array) or a combination of some of these circuits.

In the case where the processing circuitry is the processor 101, an information provision program according to the first embodiment is implemented by software, firmware or a combination of software and firmware. The software and the firmware are described as programs and stored in the memory 102. The processor 101 is capable of implementing the functions of the units shown in FIG. 2 by reading out and executing the information provision program stored in the memory 102 as a storage medium i.e., a record medium. The storage medium may be a non-transitory computer-readable storage medium storing a program such as the information provision program.

It is also possible to implement part of the information provision device 100 by dedicated hardware and implement part of the information provision device 100 by software or firmware. As above, the processing circuitry is capable of implementing the functions of the functional blocks shown in FIG. 2 by hardware, software, firmware, or a combination of some of these means.

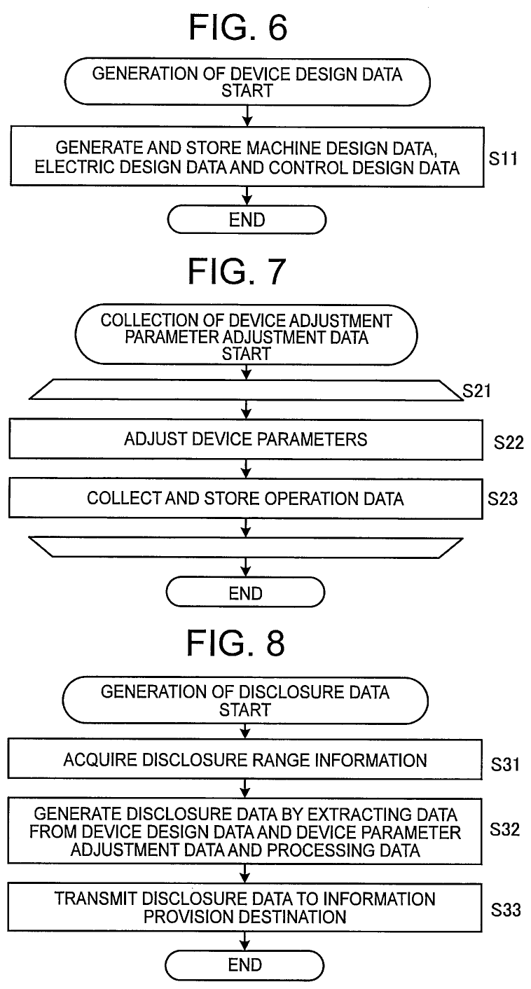

FIG. 6 is a flowchart showing a generation process of the device design data. The device design data generation unit 11 generates the machine design data, the electric design data and the control design data and stores these data in the device design data DB 11a (step S11).

FIG. 7 is a flowchart showing a generation process of the device parameter adjustment data. The device parameter adjustment data generation unit 12 repeatedly executes a process (step S21) of adjusting the device parameters of the testing target device 20 (step S22) and collecting operation data and storing the operation data in the device parameter adjustment data DB 12a (step S23).

FIG. 8 is a flowchart showing a generation process in the disclosure data generation unit. The disclosure data generation unit 110 acquires the disclosure range information (step S31), generates the disclosure data by extracting data from the device design data and the device parameter adjustment data depending on the disclosure range information and processing the data (step S32), and transmits the disclosure data to the information provision destination (step S33).

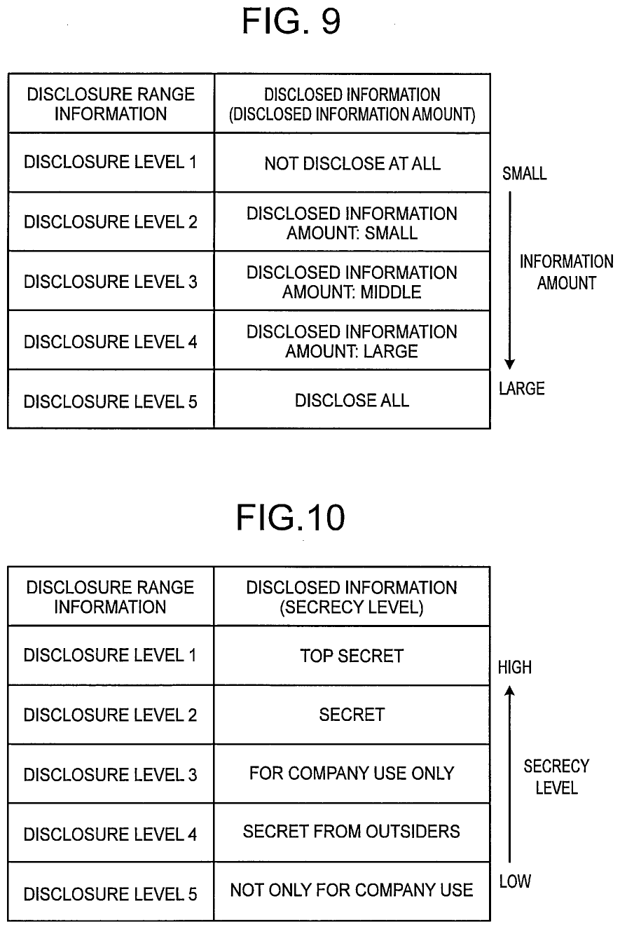

FIG. 9 is a diagram showing examples of the disclosure range information and disclosed information. In the examples in FIG. 9, the disclosure range information is represented by disclosure levels 1 to 5, and an information amount of the disclosure data to be provided to the information provision destination has been determined for each of the disclosure levels 1 to 5. In the case of the examples in FIG. 9, the data regarding the target device 40 are not disclosed at all in the disclosure level 1, the disclosed information amount of the disclosure data regarding the target device 40 is small in the disclosure level 2, the disclosed information amount of the disclosure data regarding the target device 40 is middle in the disclosure level 3, the disclosed information amount of the disclosure data regarding the target device 40 is large in the disclosure level 4, and all of the data regarding the target device 40 are disclosed in the disclosure level 5.

FIG. 10 is a diagram showing examples of the disclosure range information and the disclosed information. In the examples in FIG. 10, the disclosure range information is represented by the disclosure levels 1 to 5, and a secrecy level regarding the disclosure data to be provided to the information provision destination has been determined for each of the disclosure levels 1 to 5. In the case of the examples in FIG. 10, the data regarding the target device 40 is handled as “top secret” in the disclosure level 1, the data regarding the target device 40 is handled as “secret” (i.e., secret) in the disclosure level 2, the data regarding the target device 40 is handled as “for company use only” in the disclosure level 3, the data regarding the target device 40 is handled as “secret from outsiders” (i.e., secret within those concerned) in the disclosure level 4, and the data regarding the target device 40 is handled as “not only for company use” (i.e., not for company use only) in the disclosure level 5.

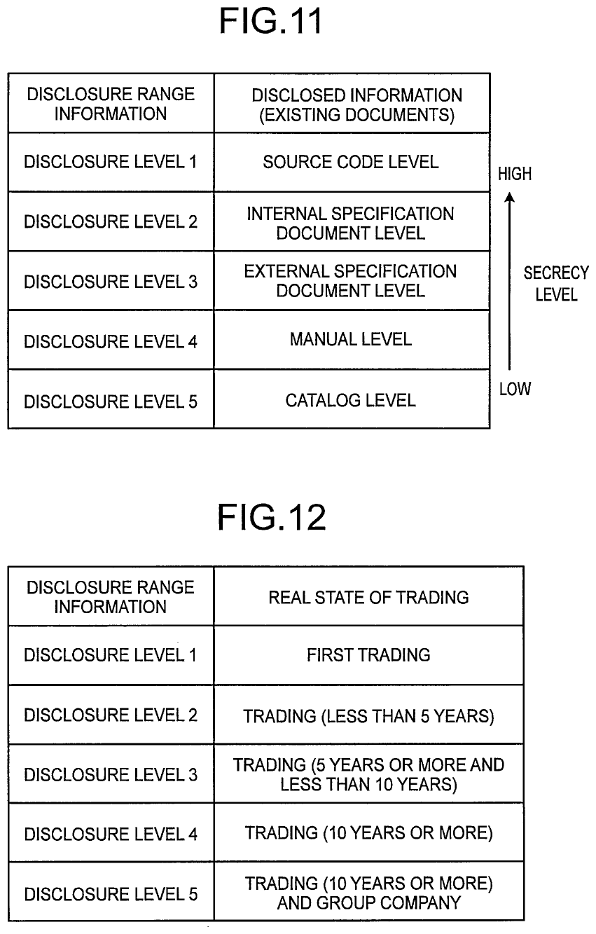

FIG. 11 is a diagram showing examples of the disclosure range information and the disclosed information. In the examples in FIG. 11, the disclosure range information is represented by the disclosure levels 1 to 5, and the range of the disclosure data to be provided to the information provision destination has been determined for each of the disclosure levels 1 to 5. In the case of the examples in FIG. 11, the disclosure data includes information at the level of source codes included in already-existing documents in the disclosure level 1, the disclosure data includes information at the level of internal specification documents included in the already-existing documents in the disclosure level 2, the disclosure data includes information at the level of external specification documents included in the already-existing documents in the disclosure level 3, the disclosure data includes information at the level of manuals included in the already-existing documents in the disclosure level 4, and the disclosure data includes information at the level of catalogs included in the already-existing documents in the disclosure level 5.

FIG. 12 is a diagram showing an example of a relationship between the disclosure range information and the real state of trading. In the example in FIG. 12, the disclosure range information is represented by the disclosure levels 1 to 5, and the disclosure levels 1 to 5 have been determined depending on the real state of trading with the information provision destination. The disclosure level 1 is given when the information provision destination is a new partner of trading. the disclosure level 2 is given when there has been trading with the information provision destination for less than five years, and the disclosure level 3 is given when there has been trading with the information provision destination for five years or more and less than ten years. Further, the disclosure level 4 is given when there has been trading with the information provision destination for more than or equal to ten years, and the disclosure level 5 is given when there has been trading with the information provision destination for more than or equal to ten years and the information provision destination is a group company.

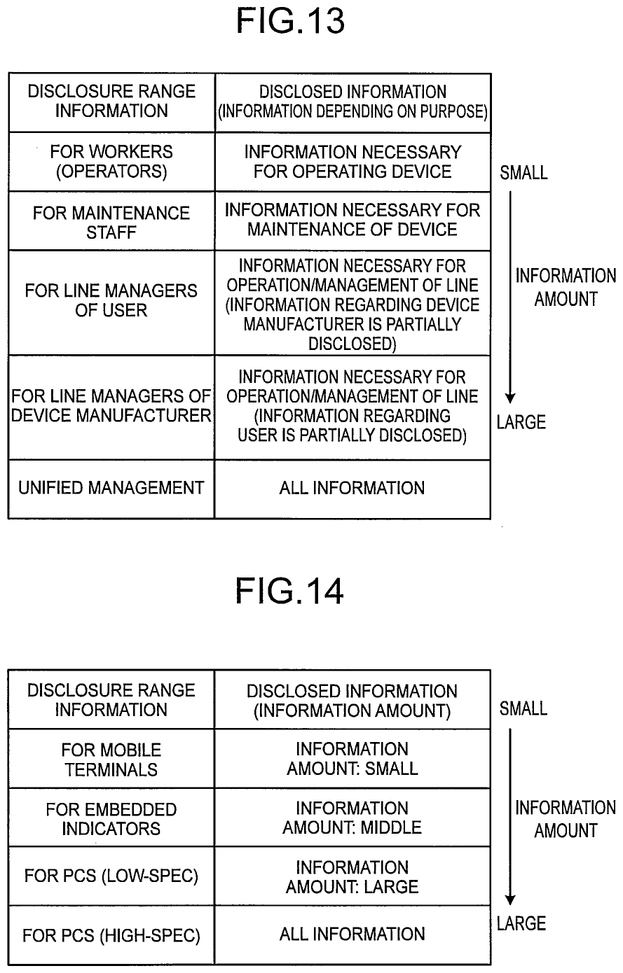

FIG. 13 is a diagram showing examples of the disclosure range information and the disclosed information. In the examples in FIG. 13, for workers (operators), for maintenance staff, for line managers of the user, for line managers of the device manufacturer, and unified management have been prescribed as the disclosure range information. In the case of the examples in FIG. 13, the disclosure data is information necessary for operating the device when the disclosure range information is for workers, and the disclosure data is information necessary for maintenance of the device when the disclosure range information is for maintenance staff. Further, the disclosure data is (partially limited) information necessary for operation and management of the line when the disclosure range information is for line managers of the user, the disclosure data is (unlimited) information necessary for the operation and management of the line when the disclosure range information is for line managers of the device manufacturer, and the disclosure data is (unlimited) information necessary for the operation and management of the line when the disclosure range information is unified management.

FIG. 14 is a diagram showing examples of the disclosure range information and the disclosed information. In the examples in FIG. 14, for mobile terminals, for embedded indicators, for PCs (low-spec), and for PCs (high-spec) have been prescribed as the disclosure range information. In the case of the examples in FIG. 14, the information amount of the disclosure data is small when the disclosure range information is for mobile terminals, and the information amount of the disclosure data is middle when the disclosure range information is for embedded indicators. Further, the information amount of the disclosure data is large when the disclosure range information is for PCs (low-spec), and the information amount of the disclosure data is all information when the disclosure range information is for PCs (high-spec).

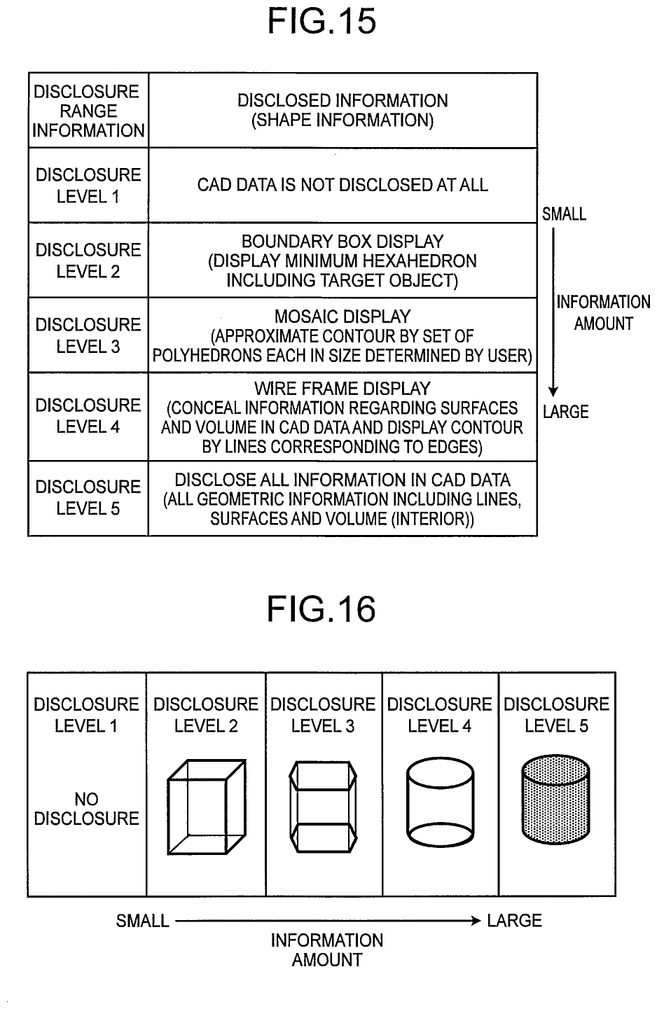

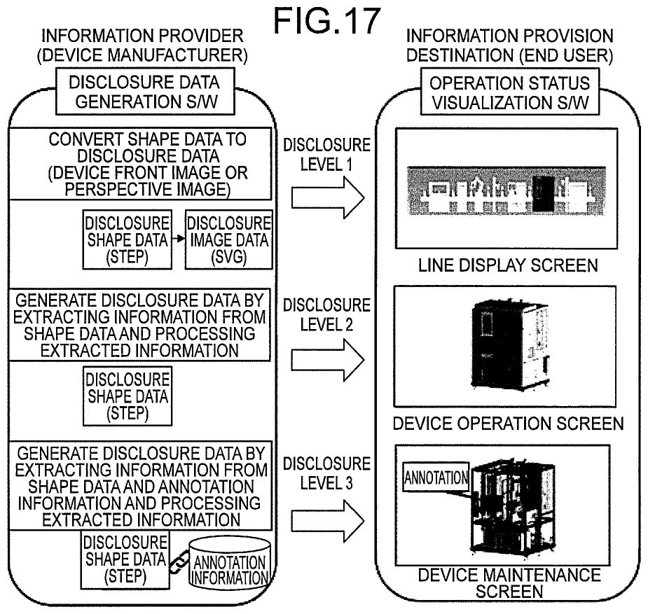

FIG. 15 is a diagram showing examples of the disclosure range information and the disclosed information. FIG. 16 is a diagram showing examples of a disclosed shape in the examples in FIG. 15. In the examples in FIG. 15 and FIG. 16, the disclosure range information is represented by the disclosure levels 1 to 5, and the disclosure levels 1 to 5 have been determined depending on the real state of trading with the information provision destination. In the case of the examples in FIG. 15 and FIG. 16, CAD data are not disclosed at all in the disclosure level 1, boundary box display is performed in the disclosure level 2, mosaic display is performed in the disclosure level 3, wire frame display is performed in the disclosure level 4, and all the information in the CAD data is disclosed in the disclosure level 5. In the boundary box display, a minimum hexahedron (rectangular solid) including a target object is displayed. In the mosaic display, a shape obtained by approximating a contour by using a set of polyhedrons each in a size determined by the user is displayed. In the wire frame display, information regarding surfaces and the volume of the shape generated by using the CAD is concealed and the contour is displayed by lines corresponding to edges. In the disclosure level 5, all geometric information including lines, surfaces and the volume (interior) is displayed.

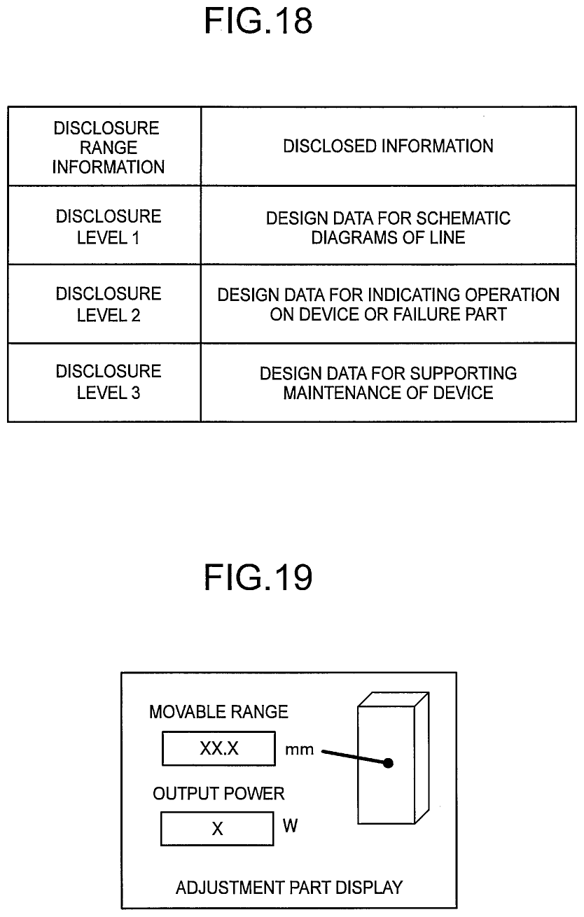

FIG. 17 is a diagram showing examples of the disclosed information. FIG. 18 is a diagram showing the disclosed information in the examples in FIG. 17. In the examples in FIG. 17 and FIG. 18, the disclosure range information is represented by the disclosure levels 1 to 3, and the disclosure levels 1 to 3 have been determined according to requests from the device manufacturer as the information provider.

In the disclosure level 1, the manufacturer-side PC 10 provides data necessary for visualization of a line display screen (FIG. 17). For example, the manufacturer-side PC 10 provides external appearance information on the device deformed (i.e., expressed by deforming the target object) by removing classified information from the machine design data. In this case, the manufacturer-side PC 10 may convert the shape data extracted from the design data into image data or a PDF (Portable Document Format) file and provide the image data or the PDF file. By this method, the design data can be diverted to images in comparison with cases where schematic diagrams are drawn from scratch by using visualization software, and thus the amount of work necessary for drawing diagrams is reduced. Further, the manufacturer-side PC 10 is capable of outputting schematic diagrams based on data obtained by removing classified information from the design data. Furthermore, since schematic diagrams coinciding with the external appearance of the device are displayed in contrast with cases where images of a similar device preset in the visualization software are used, the external appearance of the device is easily understandable from the schematic diagrams.

In the disclosure level 2, the manufacturer-side PC 10 provides data necessary for visualization of operation screens of the device. For example, the manufacturer-side PC 10 extracts the external appearance information on the device from the machine design data, processes the external appearance information, and provides the processed information. The provided data undergoes operations such as enlargement/reduction, movement and rotation in the user-side PC 30 at the information provision destination, by which the end user using the user-side PC 30 is enabled to check detailed information. Further, the user-side PC 30 is capable of performing the display while linking (associating) an object provided by the visualization S/W, such as a lamp or a numerical display, with the design data. For example, the user-side PC 30 is capable of performing the display while associating an object such as a lamp or a numerical display with the design data by using a leader line extending from the shape data. This enables the user to intuitively understand the correspondence between the external appearance of the device and the object FIG. 19 is a diagram showing an example of a screen displaying an object in a rectangular solid shape and design data (movable range [mm], output power [W]) while associating them with each other.

In the disclosure level 3, the manufacturer-side PC 10 provides data necessary for visualization of device maintenance screens. For example, the manufacturer-side PC 10 provides inside information regarding the device, electric wiring, a ladder program, device adjustment parameters, annotation information, and so forth. The user-side PC 30 displays the provided data while linking (associating) the data with the shape data and each object such as a button or a text as a screen component for visualization so that these items of detailed information can be checked. For example, the user-side PC 30 is capable of displaying information of the device parameter adjustment data such as an adjustment method and adjustment values of the device on the device maintenance screen in the state of having been associated with the shape data. In the disclosure level 3, the device parameter adjustment data is included in the provided data differently from the case in the disclosure level 2, and thus the end user can not only intuitively understand the device's part that should be operated but also learn what type of operation should be performed on the part or what kind of value(s) should be set to the part. This reduces the number of times the device manufacturer receives an adjustment support request from the end user, by which the amount of work and the time necessary for the adjustment support can be reduced. The end users become able to perform the adjustment and the maintenance of the device on their own based on the disclosure design data and the device parameter adjustment data (i.e., communication for requesting the device manufacturer to provide support becomes unnecessary and the end users become able to immediately deal with the adjustment and the maintenance on their own), and the production efficiency increases. In this case, it is possible to employ a configuration including an adjustment support library that makes operation status visualization S/W execute machine learning by using the device parameter adjustment data as the input and outputs recommendation values of the settings.

A laser processing machine of a generic type includes a laser oscillator that emits a laser beam, an optical path through which the laser beam travels, a processing head that condenses and emits the laser beam, and a table on which a plate-like material is arranged. At the time of laser processing, a plate-like material as the target of the processing is arranged on the table of the laser processing machine, the processing head is moved according to a coordinate system of the laser processing machine, and the processing is performed by the emission of the laser beam. The device manufacturer of the laser processing machine performs machine design by using machine CAD software, electric design by using electric CAD software, and control program design by using control software based on specifications requested from the end user, and stores each item of design data in a file format supported by the respective software program. Thereafter, an integrative model is generated by inputting those items of design data to software for design information coordination compatible with AutomationML or the like, and design verification and management of the design data are carried out. In this case, the design data are classified information, and thus cannot be disclosed to the end user without modification.

Subsequently, after the real machine of the target device is completed, the device manufacturer performs the parameter adjustment of the target device to suit the use environment of the end user. For example, adjustment of the movable range of the processing head, adjustment of the output power value of the laser beam, and so forth are performed depending on the size and material type of the metal plate handled by the end user. In this case, the adjustment of the device parameters is made to optimum values by means of know-how or trial and error by an adjustment worker on the device manufacturer's side. The results of the trial and error performed at the time of the device parameter adjustment are recorded as history records of the device parameter adjustment. The device parameter adjustment data are also classified information for the device manufacturer, and thus cannot be disclosed to the end user without modification.

Subsequently, the target device is delivered from the device manufacturer to the end user. At the time of the delivery, operation guidance is given to the end user from the device manufacturer. Further, information materials such as a manual and assembly drawings are delivered separately from the design data.

Subsequently, the end user carries out the operation of the target device based on the operation guidance and the delivered information materials. The end user starts the operation of the target device based on the contents of the operation guidance received at the time of the delivery and the delivered information materials. However, not being an expert on the target device, the end user, even being capable of using the target device in basic ways, is incapable of changing the adjustment values or dealing with particular errors and there are cases where the end user cannot make full use of the target device. In such cases, the end user needs to inquire of the device manufacturer about how to change the adjustment values of the device or how to deal with an error, or to make a request for dealing with trouble. This works as a factor increasing the time it takes for the end user to solve trouble with the device. On the other hand, for the device manufacturer, there occurs an increase in the time spent for changing the adjustment values, dealing with a particular error, and the like, apart from originally required tasks.

Further, due to the request for the visualization of devices in recent years, a screen for displaying an external view or the like of the device on the display device or the visualization S/W is generated; however, the design data cannot be acquired from the device manufacturer and thus the end user needs to newly draw the external view of the device by using the currently used display device and drawing software or the like adjunct to the visualization S/W.

With the information provision device 100 according to the first embodiment, disclosure range control is performed on the device design data possessed by the device manufacturer, and the disclosure data such as the disclosure integrative model are outputted and provided to the end user. Specifically, the disclosure data is provided by controlling the disclosure level as shown in FIG. 8, by which the time and manpower that have to be spent by the device manufacturer can be reduced and the end user is enabled to view necessary information.

As described above, with the information provision device 100 according to the first embodiment, the disclosure range of the disclosure data can be set flexibly according to the disclosure range information. The end user acquires the device design data and the device parameter adjustment data from the device manufacturer and that makes it possible to set optimum parameters and shorten the setting time.

Further, with the information provision device 100 according to the first embodiment, the disclosure range can be controlled with detailed granularity in regard to not only the machine design data linked with the shape information but also the electric design data, the control design data and the device parameter adjustment data not linked with the shape information.

Furthermore, the disclosure range information can also be a combination of a plurality of items of information (e.g., a combination of disclosure level information, disclosure period information, information indicating an instrument as the target of the disclosure, information indicating a condition for the disclosure target, and so forth).

### Second Embodiment

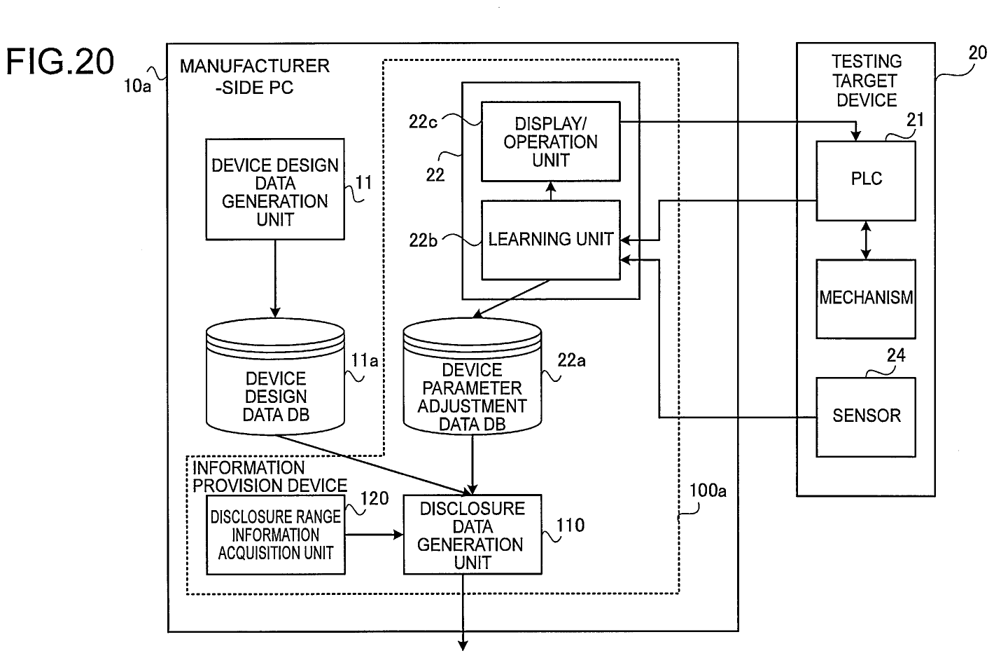

FIG. 20 is a diagram showing a configuration of a system employing an information provision device 100a according to a second embodiment. In FIG. 20, at the time of adjusting the device parameters determining the operation of the target device 40, a device parameter adjustment data generation unit 22 collects values indicating the operational status of the target device 40 or the testing target device 20 (control signals from the PLC 21) and output values from the sensors 24 included in the target device 40 or the testing target device 20 as adjustment data, and generates the device parameter adjustment data based on the collected adjustment data. For example, the device parameter adjustment data generation unit 22 generates the device parameter adjustment data by means of machine learning by use of a display/operation unit 22c for operating the PLC 21 and a learning unit 22b.

The learning unit 22b generates a learned model based on the collected adjustment data and outputs recommendation values or the like obtained by the model. Specifically, the learning unit 22b first generates data shaped/processed as a learning data set from the collected adjustment data. Subsequently, the learning unit 22b generates a learning program for generating learned parameters, by using the learning data set. Subsequently, the learning unit 22b generates the learned parameters as the result of inputting the learning data set to the learning program. Subsequently, the learning unit 22b generates the learned model as a learned program in which the learned parameters have been embedded. By the learned model generated as above, recommended set values for performing the optimum operation of the device in response to input data are generated as the device parameter adjustment data, by which the parameter adjustment of the device can be supported. Here, while Bayesian optimization or the like can be considered as the method of generating the learned model, the machine learning technique that can be employed is not limited to Bayesian optimization.

As described above, with the information provision device 100a according to the second embodiment, the disclosure range of the disclosure data can be set flexibly according to the disclosure range information. The end user acquires the device design data and the device parameter adjustment data from the device manufacturer, by which optimum parameters can be set or the setting time can be shortened.

Except for the above-described features, the second embodiment is the same as the first embodiment.

### Third Embodiment

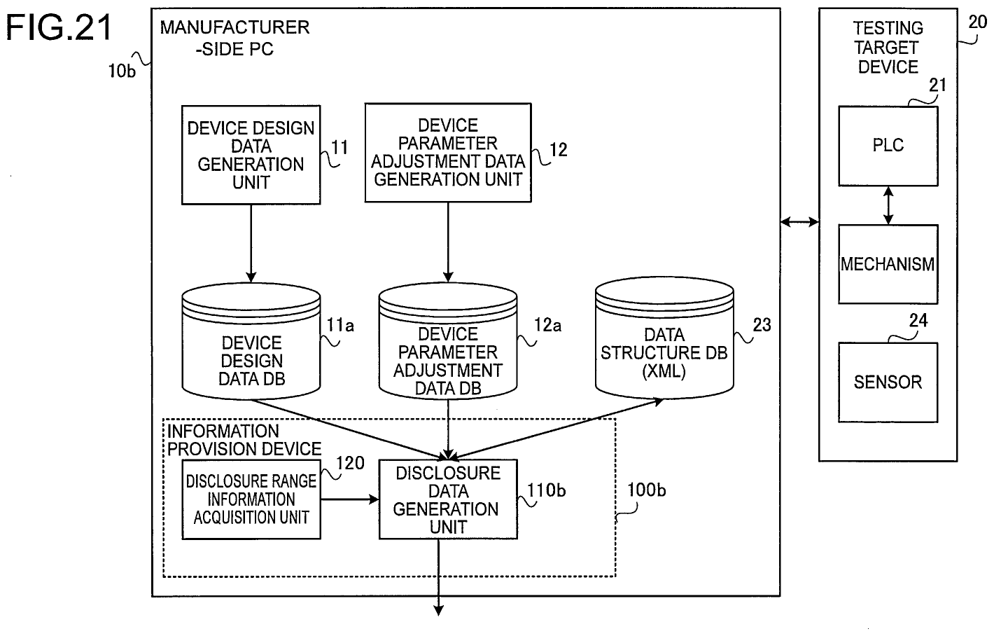

FIG. 21 is a diagram showing the hardware configuration of a system employing an information provision device 100b according to a third embodiment.

The device design data are stored as the device design data DB 11a in the storage device in a format of a composite document including character strings to which reference data (i.e., reference information) has been added, and a disclosure data generation unit 110b extracts data from the device design data DB 11a by referring to the reference data depending on the disclosure range information and generates the disclosure data based on the extracted data. The reference data includes at least one of attribute data regarding the configuration of the target device 40, the name of the configuration of the target device, and tag data assigned to the configuration of the target device 40.

A composite document (e.g., XML composite document) linked (associated) with the device design data and the device parameter adjustment data and previously generated has been stored as a data structure DB 23 in the storage device, and the disclosure data generation unit 110b extracts character strings from the composite document depending on the disclosure range information, extracts data linked with the extracted character strings from the device design data and the device parameter adjustment data, and generates the disclosure data based on the extracted data.

As described above, with the information provision device 100b according to the third embodiment, the disclosure range of the disclosure data can be set flexibly according to the disclosure range information. The end user acquires the device design data and the device parameter adjustment data from the device manufacturer and that makes it possible to set optimum parameters and shorten the setting time.

Further, compared to cases where relevance is judged by using a table, the processing speed increases in the case where character strings are extracted from the composite document depending on the disclosure range information, data linked with the extracted character strings are extracted from the device design data and the device parameter adjustment data, and the disclosure data is generated based on the extracted data.

Except for the above-described features, the third embodiment is the same as the first or second embodiment.

### Fourth Embodiment

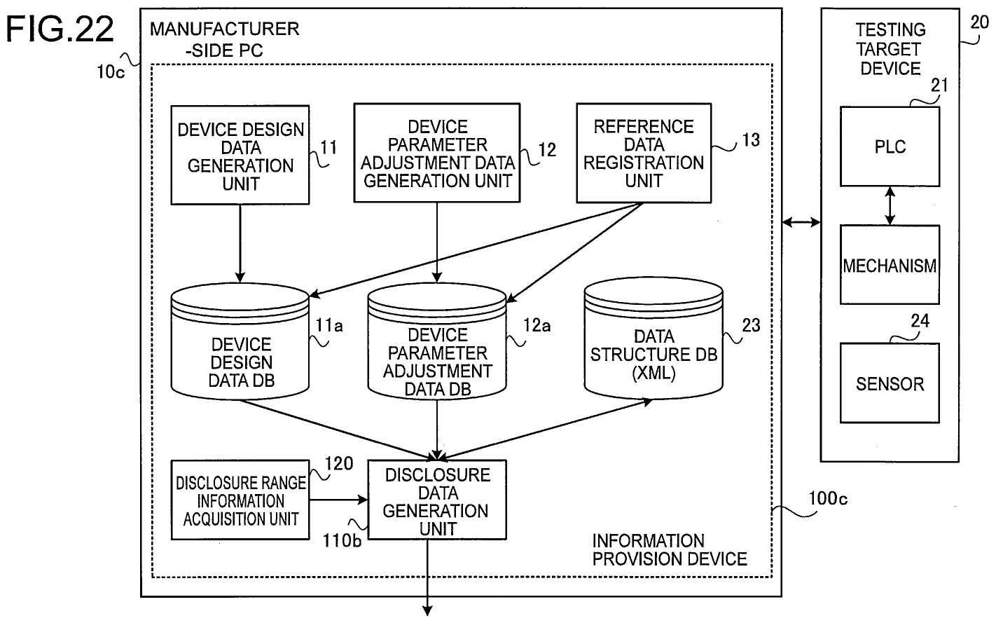

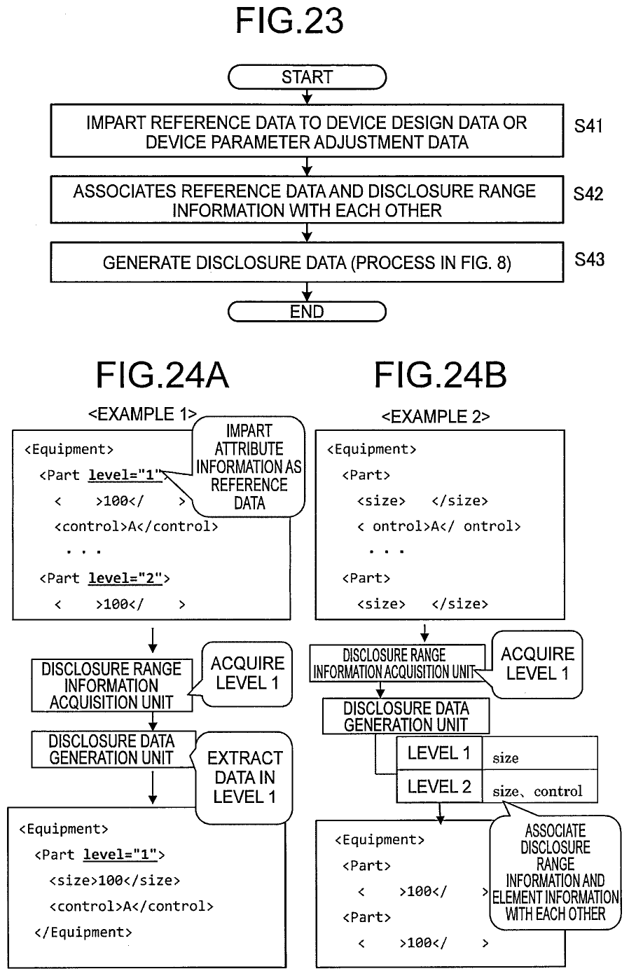

FIG. 22 is a diagram showing the hardware configuration of a system employing an information provision device 100c according to a fourth embodiment. The information provision device 100c further includes a reference data registration unit 13 that imparts reference data to be used for extracting and processing data depending on the disclosure range information, to the device design data or the device parameter adjustment data. Further, an example in which the device design data generation unit 11, the device parameter adjustment data generation unit 12, the reference data registration unit 13 and the various databases are parts of the information provision device 100c is shown in FIG. 22. However, the databases may be stored in a storage device different from the information provision device 100c.

FIG. 23 is a flowchart showing a generation process of the disclosure data executed by the information provision device 100c. The information provision device 100c imparts the reference data to the device design data or the device parameter adjustment data (step S41), associates the reference data and the disclosure range information with each other (step S42), and executes the generation process of the disclosure data shown in FIG. 8 (step S43).

### (Example of Imparting Reference Data in XML Format)

For example, the reference data registration unit 13 manages the device design data and the device parameter adjustment data in the XML (Extensible Markup Language) format and imparts the reference data, as attribute information or element information to be handled in the XML format, to the device design data or the device parameter adjustment data. In XML, the meaning and sentence structure of the data can be described by using tags defined by the user, and thus it is possible to extract and process information according to the disclosure range information by describing the data structure of the design data in the XML format, imparting the reference data as the attribute information or the element information to the data, and applying an XML conversion engine and a filter to the data.

For example, in XML, an element and an attribute are described as below.
<Element attribute=“value of attribute”>
contents of element</element>

FIG. 24A shows an example 1 in which the reference data is imparted as the attribute information in XML and information is extracted according to the disclosure range information. In the example 1, an XML file is configured so that there are a plurality of parts (Parts) in a device (Equipment) and there are a plurality of elements such as size (size) and control information (control) in each part. In this case, for example, a level (Level) for the linking with the disclosure range information is previously imparted as the attribute information to the part. Accordingly, when the disclosure range information is designated so as to extract information in the level 1, the information is extracted by referring to the attribute information and is outputted.

FIG. 24B shows an example 2 in which a part of data included in the device design data and the device parameter adjustment data is handled as the reference data and information is extracted according to the disclosure range information. In the example 2, the XML file is substantially the same as the XML file in the example 1 and the only difference from the XML file in the example 1 is that the attribute information is not imparted as the reference data. In the example 2, in order to handle a part of data included in the device design data and the device parameter adjustment data as the reference data, attribute information on each item of data and the disclosure range information are associated with each other and held in a reference table. For example, the attribute information on size is associated with the level 1 as the disclosure range information and previously held in the reference table. In this case, when the disclosure range information is designated so as to extract information in the level 1, the table is referred to and data having the attribute information on size corresponding to the level 1 are extracted from the XML file.

### (Example of Imparting Reference Data in STEP Format)

While methods in which the reference data registration unit 13 imparts the reference data in the XML format have been described above, it is also possible to impart the reference data in a different format. For example, the reference data registration unit 13 may impart the reference data by using the international standard ISO 10303 (Standard for the Exchange of Product model data: STEP) as a CAD data exchange standard. This standard has defined a data model for exchanging product design information such as shape data, assembly structure and annotation information (dimensions, tolerances) regarding a product, and description in the XML format is also possible. In the STEP format, particular characters can be set as a “Label” that each element has. For example, if reference data “Level 1” is imparted to the Label as described below, the disclosure range information acquisition unit 120 can extract only data whose Label is “Level 1”.

An example of imparting “Level 1” as the Label to data of CARTESIAN POINT describing a point will be shown below.

(1) Format
CARTESIAN POINT (Label name, (x-coordinate, y-coordinate, z-coordinate)),

(2) Example
#1=CARTESIAN POINT (‘Level 1’, (1.0, 2.0, 3.0)).

The reference data registration unit 13 imparts reference data using security_classification_level in the STEP format. Further, since secrecy classification can be set to each element in the STEP format by using security_classification_level, it is also possible to handle the secrecy classification as the reference data. Entities relevant to security_classification_level have the following specifications, for example:

An entity security_classification in Table 1 shown below defines the level of confidentiality required for the purpose of product data protection.

TABLE 1

| ENTITY | Attribute | |
|---|---|---|
| security_classification | Population | REMARKS |
| Name | type: | LABEL FOR RECOGNIZING |
| | label = string | security_classification. |
| Purpose | type: | INFORMALLY EXPLAINING |
| | text = string | INTENTION OF |
| | | security_classification. |
| Security_level | type: | DESIGNATING NECESSARY |
| | entity = | SECURITY LEVEL. |
| | security_- | DEFINING |
| | classification_level | security_classification_level. |

An entity security_classification_level in Table 2 shown below defines a category of security necessary for the product data protection.

TABLE 2

| ENTITY | Attribute | |
|---|---|---|
| security_classification_level | Population | REMARKS |
| Name | type: | LABEL FOR LEARNING |
| | label = string | security_classification_level. |

An entity applied security_classification_assignment in Table 3 shown below defines the type of security_classification-assignment that assigns security_classification to security_classification_item.

TABLE 3

| | Attribute | |
|---|---|---|
| applied_security_classification_assignment | Population | REMARKS |
| assigned_security_classification | type: | Assigned_security_classification |
| | entity = | IS ASSOCIATED |
| | security_classification | WITH PRODUCT DATA. |
| | | PROVIDING |
| | | security_classification. |
| items | type: | SET [1:?] |
| | entity = | SET OF ITEMS TO WHICH |
| | security_classification_item | security_classification HAS |
| | | BEEN ASSIGNED. |
| | | SECURITY CLASSIFICATION IS |
| | | ONE INSTANCE OF ASSIGNED |
| | | security_classification AND |
| | | IS ASSIGNED TO A PLURALITY OF |
| | | ITEMS. |

The secrecy classification can be set to each element by a description like that in the following Table 4 by use of the aforementioned entities:

```
TABLE 4
#180 = PRODUCT_DEFINITION_FORMATION (‘1’, ‘’, #170);
#190 = PRODUCT_DEFINITION (‘vp’, ‘design view part’, #180, #110);
#240 = NEXT_ASSEMBLY_USAGE_OCCURRENCE (‘p_usage_1’, ‘single
  instance usage’, ‘’, #100, #190, $);
#250 = SECURITY_CLASSIFICATION (‘confidentiality’, ‘classify as
  confidental’, #260);
#260 = SECURITY_CLASSIFICATION_LEVEL (‘confidential’);
#270 = APPLIED_SECURITY_CLASSIFICATION_ASSIGNMENT (#250, (#180,
#190, #240));
```

In Table 4, #250 is security_classification, and by putting the label “Name=confidentiality”, a sentence explaining the intention is described as “Purpose=classify as confidential”, and the contents of #260 are designated as the level of the security.

In Table 4, #260 is security_classification_level, and defines a category “Name=confidential” of the security necessary for the product data protection. In this definition, an intended category such as Top Secret (top secret), Secret (secret), Confidential (for company use only) or Restricted (handle with care) is set.

In Table 4, #270 is security_classification_assignment, and assigns assigned_security_classification in #250 to the items in #180, #190 and #240. As above, the reference data registration unit 13 is capable of imparting the secrecy classification as the reference data to the STEP file by using security_classification_level.

The reference data is imparted to the design data in each design phase. For example, when the device manufacturer performs the design, two types of design can be performed: bottom-up design and top-down design. The bottom-up design is assembly design dependent on components, in which details of each component have previously been determined and the assembly is advanced from the components towards the entire device. In contrast, in the top-down design, the conception of the overall picture is built first and then detailed component shapes are designed and improved. In the top-down design, the shape of the overall picture (layout) is designed first, and thereafter the entire design is “taken apart” into individual components and the detailed shapes of the components are designed. Thereafter, to allow machine work or the like, detailed design, including design of dimensional tolerances, geometric tolerances, surface roughness and work instructions about surface treatment and the like, is performed.

In this regard, the flow of a process of imparting the reference data will be described below. The designer first performs the design of the overall picture (layout). Subsequently, in regard to the design data of the overall picture (layout), “Level 1” as the reference data is imparted to each element in a lump. Subsequently, the designer performs the detailed design of the component shapes. Subsequently, “Level 2” as the reference data is imparted in a lump to design data added at the time point of completion of the detailed design of the component shapes, namely, design data at the time point of the completion of the detailed design of the component shapes to which “Level 1” as the reference data has not been imparted.

Subsequently, the designer adds work instructions necessary for the manufacture, such as dimensional tolerances, geometric tolerances, allowable limits of dimensions, surface texture, surface roughness, surface treatment and welding symbols. Subsequently, “Level 3” as the reference data is imparted in a lump to design data added at the time point of completion of the addition of the work instructions, namely, design data at the time point of the completion of the addition of the work instructions to which “Level 1” or “Level 2” as the reference data has not been imparted.

By imparting the reference data in each phase of generating the design data as above, the disclosure data can be generated by the disclosure data generation unit 110b depending on the disclosure range information acquired by the disclosure range information acquisition unit 120.

Further, also in cases of the bottom-up design, the disclosure range can be controlled by imparting the reference data in regard to each design phase in the same way. Furthermore, besides the above-described methods, it is also possible to additionally describe operational information or maintenance information in the design data and manage the data by imparting the reference data to pertinent information.

The function of imparting the reference data may be implemented either as a function of various types of CAD software or as a function of software independent of the CAD software.

Furthermore, while the method of imparting the reference data in each design phase is described above, it is also possible to impart the reference data to each item of design data after the completion of the entire design.

### (Data Extraction Method Based on Reference Data (Pull Parsing))

The attribute information and the element information in XML can be extracted by the following method, for example.

In pull parsing, an XML document is successively read in in the sequential order from the beginning, and is handled as a flow of a sequence of items by using a design pattern being an iterator pattern. An “iterator” generated in the pull parsing sequentially visits various elements, attributes, and data in the XML document. In a process, a program using the “iterator” investigates the present item (e.g., start of an element, end of an element, text) and investigates properties of the present item (e.g., name of the element, name space, attribute values, contents of the text). Then, it is also possible to command the iterator to move to the “next” item. The program is capable of scanning the XML document as above and thereby extracting information from the document.

### (Data Extraction Method Based on Reference Data (XLink))

Information can be extracted from a file linked with XML by the following method, for example. The XML linking language (XLink) is a language for describing link relationships formed between resources as the targets of forming a link, such as files storing XML data, elements/attributes in XML, and character strings. Links described in XLink can be roughly classified into two groups: simple links and extended links. The simple link is a link formed unidirectionally from one resource to another resource. The extended link is a link formed towards a plurality of resources, or a link formed bidirectionally. A meaning can be given to a resource or a link by attaching an additional attribute to the link. For example, a link name or explanation, the type of a resource, the role to be played by the link destination, and so forth can be described in the link. Further, a link can be formed without modifying the resources between which the link is formed.

### (Data Extraction Method Based on Reference Data (XPointer))

The XML pointer language (XPointer) is a language for designating the targets of forming a link in detail. As the link destination, it is possible not only to designate the entire file of the XML data and designate an element to which an identifier (e.g., id attribute) has been attached but also to designate something like the m-th element (m: natural number) when the same elements are arranged in sequence or designate something like the n-th character (n: natural number) in text data as the contents of an element.

In XLink, relevant files can be linked to a data structure in XML, and thus shape data or device parameter adjustment data that cannot be described in the data structure in XML can be linked as link data. In contrast, in XPointer, not the entire file of the XML data but a part can be designated as the link destination, and thus it is possible, for example, to designate a condition such as a period or a target component in regard to the linked data and thereby extract and process a part of the link destination data.

An example of S/W including the disclosure range information acquisition unit 120 and the disclosure data generation unit 110b will be shown below. The S/W has a design data display region for displaying an image of the design data, a data structure display field for showing a tree display of the structure of the design data, and a disclosure range designation field used for setting the disclosure range information by a user operation.

If design data to which the reference data has been imparted is inputted previously, elements of the design data are searched for and the secrecy classifications defined by the imparted reference data are displayed in a list display. When the design data is inputted to the S/W, the reference data are searched for and information for the disclosure range designation based on the imparted reference data is displayed in the disclosure range designation field. For example, if “Level 1” to “Level 5” have previously been imparted as the reference data, options “Level 1” to “Level 5” are displayed in the disclosure range designation field.

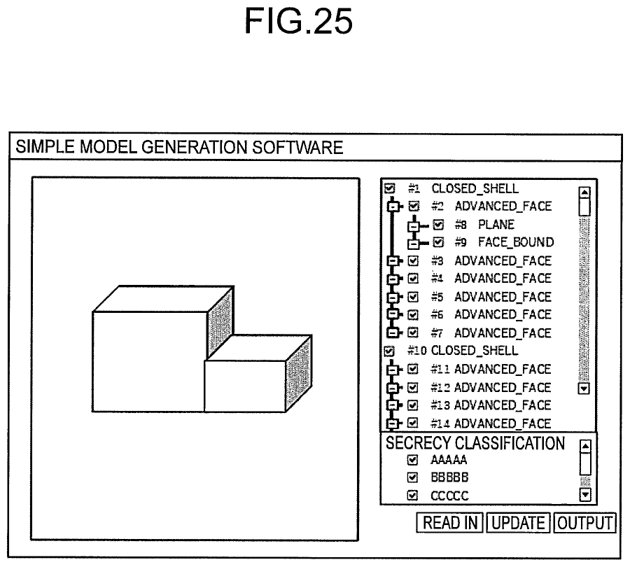

FIG. 25 is a diagram showing an example of a display screen including the disclosure range designation field. The user designates the disclosure range depending on the information provision destination by using check boxes from “Level 1” to “Level 5” in the disclosure range designation field. The disclosure range information acquisition unit 120 acquires the designated information, design data are extracted depending on the correspondence between the disclosure range information and the reference data imparted to the design data, and the extracted design data are displayed in the data structure display field or the design data display region. In the data structure display field, only check boxes of design data to which reference data corresponding to the designated disclosure range has been imparted are set at ON, and check boxes of design data not corresponding to the designated disclosure range are set at OFF. In the design data display region, only design data to which reference data corresponding to the designated disclosure range has been imparted are displayed. When the user in the state of having designated the disclosure range presses an output button, only the extracted design data are outputted as the disclosure data.

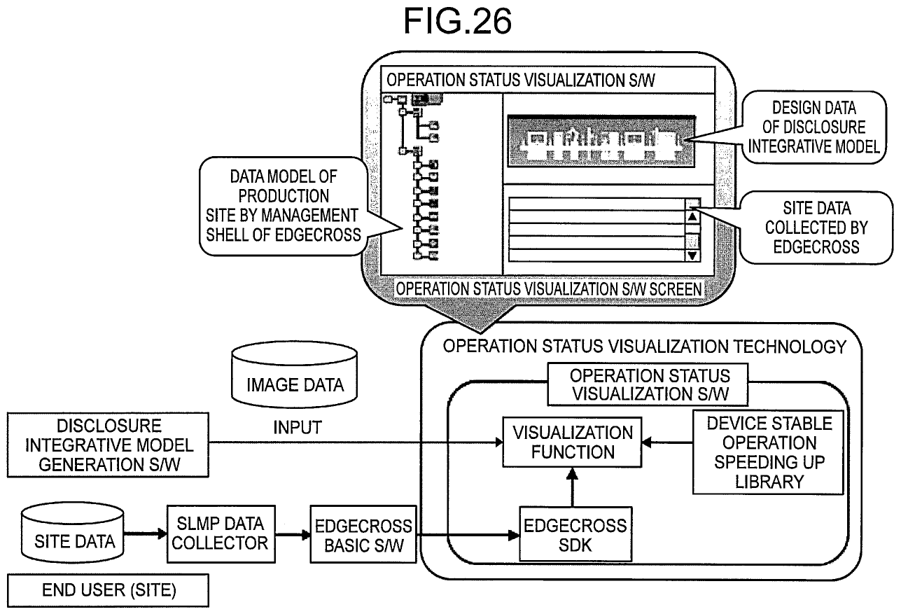

FIG. 26 is a diagram showing an example of disclosure data display S/W and the display screen. The user-side PC 30 at the information provision destination acquires the disclosure data and inputs the disclosure data to the disclosure data display S/W. The disclosure data display S/W may also be configured to integrate the design data acquired from the information provision source and data collected from the worksite and visualize the integrated data.

### (In Units of Files)

While a method of imparting the reference data to elements of an XML file or a STEP file has been described above, it is also possible to impart the reference data to header information or the like in a file and extract data in units of files.

When the machine design is performed by using machine design CAD software, a top assembly file, sub-assembly files and parts files are generated in general. The top assembly file is a file as the result of designing the entire device, and is made up of a plurality of sub-assembly files. The sub-assembly file is a file as the result of designing a plurality of instruments included in the device, and is made up of a plurality of parts files. The parts file is a file as the result of designing a component included in the instrument, and is the minimum unit of a machine design file. Each file can be stored as a STEP file.

In the STEP files, the header information can be described in each file. Each file is designated and the disclosure level information is described in the header. For example, the STEP file includes a header section for describing information on the file and a DATA section for describing the actual data. Since FILE_NAME in the header section has no strict rules about the usage of the field, the reference data designating one of “Level 1” to “Level 5” may be imparted to FILE_NAME, for example, and when “Level 1” is designated by the disclosure range information acquisition unit 120, the disclosure data generation unit 110b generates the disclosure data by extracting only files in which name=Level 1 has been described in FILE_NAME from a plurality of STEP files.

It is also possible to add a reference data registration unit to the S/W including the disclosure data generation unit 110b (e.g., input screen of the disclosure data generation S/W shown in FIG. 25) and impart the reference data by using a GUI.

For example, when a top assembly file as a STEP file and sub-assembly files and parts files linked to the top assembly file are inputted to the S/W, the shape data read in and a tree view of the files are displayed on the screen. The user selects a file from the tree view, or selects a target object from the screen displaying the shape data, and designates and saves the reference data to be imparted to the selected file by means of a pull-down operation, a key input operation or the like. In this case, as internal processing, the selected STEP file is opened, the designated reference data is appended to the header information, and the file is saved by means of overwriting.

When design data to which reference data has been imparted are inputted thereto as above, the disclosure data generation S/W outputs a disclosure model in consideration of the header information and depending on the reference data corresponding to the disclosure range selected by the user.

By this method, the design data in the disclosure range can be extracted in units of sub-assembly files or parts files. As above, it is possible to extract and process the design data according to the disclosure range by previously making the disclosure range information acquisition unit 120 impart the reference data enabling the extraction of information according to the disclosure range and making the disclosure data generation unit 110b execute conversion or filtering.

### (Disclosure Control for Device Parameter Adjustment Data)

The device parameter adjustment data may be either managed in the XML format similarly to the device design data or managed as data in the CSV format linked from the design data in the XML format. For example, by previously imparting attribute information indicating the disclosure range and information indicating a period regarding a link destination file, as the reference data, to the design data in XML, it is possible to extract design data whose attribute information is “Level 1” and further extract only data in the designated period from the device parameter adjustment data linked to the design data. Specifically, information such as the date, device setting parameters, environment parameters, material parameters and test parameters is previously described as CSV data, and information indicating the period as the target of the extraction of information from the CSV file as the link destination is designated in the XML reference data. For example, if “2021 Apr. 1”-“2021 Apr. 30” is designated as the information indicating the period, only the device parameter adjustment data regarding one month of April can be extracted and disclosed.

In this case, it is also possible to designate not only the period but also a target instrument, an environment condition and so forth. For example, a combination of a plurality of conditions may be designated, such as data in which the temperature of the environment is higher than or equal to 18° C. among the adjustment data of a device delivered from the device manufacturer to company A in April.

As the device parameter adjustment data, it is possible to either handle raw data acquired from the device or manage the learning data set obtained by processing the raw data for the learning, the learned model as the learned program in which the learned parameters have been embedded, and device parameter adjustment recommendation value information obtained by executing the learned model by linking them with each other.

As described above, with the information provision device 100c according to the fourth embodiment, the disclosure range of the disclosure data can be set flexibly according to the disclosure range information. The end user acquires the device design data and the device parameter adjustment data from the device manufacturer and that makes it possible to set optimum parameters and shorten the setting time.

Except for the above-described features, the fourth embodiment is the same as any one of the first to third embodiments.

### Fifth Embodiment

In a fifth embodiment, a description will be given of the contents of a process of extracting information necessary for the line layout design from the design data and providing the extracted information to the end user. While examples of inputting the disclosure design data to the visualization software are described in the first to fourth embodiments, the description in this embodiment will be given of a mode in which only information necessary for the line layout design, such as the dimensions or the external appearance information, is extracted from the design data and provided to the end user.

When considering the manufacturing line, the end user uses a line layout design support tool or the like. For example, an example of using the line layout design support tool described in the following document will be described below.
Non-patent Reference 1: URL “https://monoist.atmarkit.co.jp/mn/articles/2007/06/news078.html”, Kazutaka Mishima, “AI Technology for Manufacturing Site; Is That Line Configuration Really Efficient? AI Considering Optimum Production Layout”, MONOist, published on Jul. 6, 2020.

Besides cases where the line layout design is performed by the end user, there are cases where the line layout design is undertaken by the device manufacturer, cases where the line layout design is undertaken by a different SIer (System Integrator), and so forth. In such cases, at least one of the dimension information and the external appearance information is extracted as the disclosure data from the design data of the device. Thereafter, the disclosure data is inputted to line layout design software. On the line layout design software, the line layout can be designed while examining whether the device can be arranged in an intended area or not, interference with other devices, and so forth based on the dimension information while viewing displayed external appearance of the device.

As described above, with the information provision device according to the fifth embodiment, it is possible to extract only information necessary for the line layout design, such as the dimensions or the external appearance information, from the design data and provide the extracted information to the end user. The end user acquires the provided data and is thereby enabled to perform the line design while examining whether the device fits in a supposed area or not, whether the device interferes with no other devices or not, and so forth on the line layout design support tool.

Except for the above-described features, the fifth embodiment is the same as any one of the first to fourth embodiments.

### Modification

While examples of performing the disclosure control on the device design data are described in the above embodiments, it is also possible to apply the disclosure control to data such as integrative data integratively managing the process design data, product design data, end user worksite data and the machine/electric/control design data.

As for the end user worksite data, while the device manufacturer needs to collect the worksite data in order to grasp the device operation status at the worksite, the end user cannot provide the end user worksite data to the device manufacturer without modification since the worksite data includes classified information. Therefore, the disclosure range control is performed on the worksite data and the worksite data after undergoing the disclosure range control is provided to the device manufacturer. For example, the worksite data such as operational history logs and operation logs regarding the device are previously managed as CSV files or XML files and thereafter provided to the device manufacturer by means of the disclosure range control, by which the provided worksite data can be utilized for investigation as to occurrence of trouble, reproduction of a situation on a simulator, primary isolation of the cause of trouble by comparison between the operational logs and the operation logs of the device, and so forth.

While the disclosure range control in the conventional technology was only possible on information linked with the shape information at coarse granularity, the disclosure range control in the above embodiments is applicable to not only the device design data but also the device parameter adjustment data and the electric/control design data not linked with the shape information, and thus the types of data on which the disclosure control can be performed increases.

Further, compared to cases where the propriety of the provided information (item) is set depending on the disclosure level by referring to a table, the reference data can be imparted in regard to a minimum unit constituting the design data, and the disclosure control can be performed with fine granularity.

Furthermore, in the cases of referring to a table, there arises the need to hold and refer to other tables. In contrast, in the above embodiments, the reference data is directly imparted to the design data, by which unified management is made possible and the processing speed is increased compared to the cases where the relevance is judged by using a table.

The end user acquires the design data and the device parameter adjustment data for the disclosure from the device manufacturer, which makes it possible to increase the working efficiency by referring to these data at times of the operation, maintenance, troubleshooting and device parameter adjustment of the device.

### DESCRIPTION OF REFERENCE CHARACTERS

10, 10a, 10b, 10c: manufacturer-side PC, 11: device design data generation unit, 11a: device design data DB, 12, 22: device parameter adjustment data generation unit, 12a, 22a: device parameter adjustment data DB, 13: reference data registration unit, 20: testing target device, 21: PLC, 23: data structure DB, 24: sensor, 30: user-side PC, 31: disclosure device design data, 32: disclosure device parameter adjustment data, 40: target device, 100, 100a, 100b: information provision device, 101: processor, 102: memory, 103: storage unit, 104: communication unit, 110, 110b: disclosure data generation unit, 120: disclosure range information acquisition unit.

What is claimed is:

1. An information provision device comprising:
processing circuitry
to acquire disclosure range information indicating a range of information regarding a target device that is permitted to be disclosed to an information provision destination; and
to acquire device design data as data regarding design of the target device from a database storing the device design data, to acquire device parameter adjustment data as data regarding device parameters determining operation of the target device from a database storing the device parameter adjustment data, to extract data from the device design data and the device parameter adjustment data depending on the disclosure range information, and to generate disclosure data to be provided to the information provision destination, from the extracted data.

2. The information provision device according to claim 1, wherein the device design data includes one or more items of data out of machine design data as data regarding machine design of the target device, electric design data as data regarding electric design of the target device, and control design data as data regarding control design of the target device.

3. The information provision device according to claim 2, wherein
the machine design data includes data of a file generated by using a CAD tool for the machine design,
the electric design data includes data of a file generated by using a CAD tool for the electric design, and
the control design data includes data of a file for a program for the control design.

4. The information provision device according to claim 1, wherein the processing circuitry collects values indicating operational status of the target device or a testing target device and output values from sensors included in the target device or the testing target device as adjustment data at times of adjusting the device parameters determining the operation of the target device and generates the device parameter adjustment data based on the collected adjustment data.

5. The information provision device according to claim 4, wherein the processing circuitry generates the device parameter adjustment data by using machine learning.

6. The information provision device according to claim 1, wherein the processing circuitry generates the disclosure data to be provided to the information provision destination by processing the extracted data.

7. The information provision device according to claim 6, wherein the processing performed by the processing circuitry is one of a process of generating the disclosure data by concealing the extracted data by means of encryption, a process of generating the disclosure data by changing a level according to LOD technology, and a process of generating the disclosure data by replacing the extracted data with different data.

8. The information provision device according to claim 1, wherein the processing circuitry imparts reference data to be used for extracting and processing data depending on the disclosure range information, to the device design data or the device parameter adjustment data.

9. The information provision device according to claim 1, wherein the processing circuitry manages a part of data included in the device design data and the device parameter adjustment data as reference data linked with the disclosure range information.

10. The information provision device according to claim 1, wherein
the device design data is stored in a storage device in a format of a composite document including character strings to which reference data has been added, and
the processing circuitry extracts data from the device design data by referring to the reference data depending on the disclosure range information and generates the disclosure data based on the extracted data.

11. The information provision device according to claim 8, wherein the reference data includes at least one of attribute data regarding a configuration of the target device, a name of the configuration of the target device, and tag data assigned to the configuration of the target device.

12. The information provision device according to claim 1, wherein
a composite document linked with the device design data and the device parameter adjustment data and previously generated has been stored in a storage device, and
the processing circuitry extracts character strings from the composite document depending on the disclosure range information, extracts data linked with the extracted character strings from the device design data and the device parameter adjustment data, and generates the disclosure data based on the extracted data.

13. The information provision device according to claim 1, wherein the disclosure range information includes one or more items of information out of disclosure level information, disclosure period information, information indicating an instrument as a target of the disclosure, and information indicating a condition for the disclosure target.

14. An information provision method executed by an information provision device, the method comprising:
acquiring disclosure range information indicating a range of information regarding a target device that is permitted to be disclosed to an information provision destination; and
acquiring device design data as data regarding design of the target device from a database storing the device design data, acquiring device parameter adjustment data as data regarding device parameters determining operation of the target device from a database storing the device parameter adjustment data, extracting data from the device design data and the device parameter adjustment data depending on the disclosure range information, and generating disclosure data to be provided to the information provision destination, from the extracted data.

15. A non-transitory computer-readable storage medium storing an information provision program that causes a computer to execute:
acquiring disclosure range information indicating a range of information regarding a target device that is permitted to be disclosed to an information provision destination; and
acquiring device design data as data regarding design of the target device from a database storing the device design data, acquiring device parameter adjustment data as data regarding device parameters determining operation of the target device from a database storing the device parameter adjustment data, extracting data from the device design data and the device parameter adjustment data depending on the disclosure range information, and generating disclosure data to be provided to the information provision destination, from the extracted data.
